(19) United States
(12) Patent Application Publication
(10) Pub. No.: US 2014/0177294 A1
(43) Pub. Date: Jun. 26, 2014

(54) SYSTEMS AND METHODS FOR SUPPRESSING RESONANCES IN POWER CONVERTERS

(71) Applicants: Brian Eric Lindholm, Salem, VA (US); Cyrus David Harbourt, Roanoke, VA (US); Richard S. Zhang, Shanghai (CN); Yingqi Zhang, Shanghai (CN); Fan Zhang, Shanghai (CN)

(72) Inventors: Brian Eric Lindholm, Salem, VA (US); Cyrus David Harbourt, Roanoke, VA (US); Richard S. Zhang, Shanghai (CN); Yingqi Zhang, Shanghai (CN); Fan Zhang, Shanghai (CN)

(73) Assignee: General Electric Company, Schenectady, NY (US)

(21) Appl. No.: 14/237,796

(22) PCT Filed: Aug. 23, 2011
(86) PCT No.: PCT/CN2011/001404

§ 371 Date: Feb. 7, 2014

(51) Int. Cl. H02M 5/42

(52) U.S. Cl. CPC H02M 5/42
USPC 363/39

(57) ABSTRACT

Systems and methods for suppressing resonances in power converters are provided. A power converter (100) includes an input stage (101) configured to receive alternating current (AC), an output stage (102) configured to output alternating current (AC), a first direct current (DC) bus (106) coupling the input stage (101) to the output stage (102), a second DC bus (108) coupling the input stage (101) to the output stage (102), a first capacitor leg (110) coupling the first DC bus (106) to the second DC bus (108) and a second capacitor leg (112) coupling the first DC bus (106) to the second DC bus (108). The first DC bus (106), the second DC bus (108), the first capacitor leg (110), and the second capacitor leg (112) form a current loop (130) having an effective inductance, and at least one resistor (140,142) configured to suppress a resonance of the power converter (100), wherein the resonance is based at least in part on the effective inductance of the current loop.

### BACKGROUND OF THE INVENTION

The subject matter disclosed herein relates generally to power converters including two converter sections tied together with a capacitive DC link, and more specifically, to systems and methods for use in suppressing resonances in such power converters.

At least some known power converters are used to convert fixed frequency alternating current (AC) to variable-frequency AC, or vice-versa. To minimize dimensions and reduce losses, at least some known power converters include a tightly-coupled DC link in which an input of the second power converter stage is located relatively close to an output of the first power converter stage. As such, the DC busses connecting the input to the output extend a relatively short distance.

However, in at least some known distributed DC link power converters, the power converter input stage is spaced a considerable distance from the power converter output stage. Because of the distance between the input and the output stages, the DC busses connecting the two stages may produce non-trivial inductances. Such inductances, in conjunction with capacitors in the power converter, may create resonant frequencies that can be excited during operation. Operating a power converter at or near a resonant frequency, or with harmonics that are at or near a resonant frequency, may cause large ripple currents to be generated, which may cause various converter components to overheat and/or malfunction.

### BRIEF DESCRIPTION OF THE INVENTION

In one aspect, a power converter is provided. The power converter includes an input stage configured to receive alternating current (AC), an output stage configured to output AC, a first direct current (DC) bus coupling the input stage to the output stage, a second DC bus coupling the input stage to the output stage, a first capacitor leg coupling the first DC bus to the second DC bus, a second capacitor leg coupling the first DC bus to the second DC bus, the first DC bus, the second DC bus, the first capacitor leg, and the second capacitor leg form a current loop having an effective inductance, and at least one resistor configured to suppress a resonance of the power converter, wherein the resonance is based at least in part on the effective inductance of the current loop.

In another aspect, a system for suppressing resonances in a power converter is provided. The system includes an alternating current (AC) source, an AC load, and a power converter. The power converter includes an input stage configured to receive AC, an output stage configured to output alternating current AC, a first direct current (DC) bus coupling the input stage to the output stage, a second DC bus coupling the input stage to the output stage, a first capacitor leg coupling the first DC bus to the second DC bus, a second capacitor leg coupling the first DC bus to the second DC bus, the first DC bus, the second DC bus, the first capacitor leg, and the second capacitor leg form a current loop having an effective inductance. The power converter further includes at least one resistor configured to suppress a resonance of the power converter, wherein the resonance is based at least in part on the effective inductance of the current loop.

In yet another aspect, a method of suppressing resonances in a power converter is provided. The method includes providing a power converter, the power converter comprising an input stage configured to receive alternating current (AC), an output stage configured to output AC, a first direct current (DC) bus coupling the input stage to the output stage, a second DC bus coupling the input stage to the output stage, a first capacitor leg coupling the first DC bus to the second DC bus, and a second capacitor leg coupling the first DC bus to the second DC bus, the first DC bus, the second DC bus, the first capacitor leg, and the second capacitor leg form a current loop having an effective inductance. The method further includes coupling at least one resistor within the power converter, and suppressing a resonance of the power converter using the at least one resistor, the resonance based at least in part on the effective inductance of the current loop.

### BRIEF DESCRIPTION OF THE DRAWINGS

FIG. 1 is a schematic diagram of an exemplary power converter.

FIG. 2 is a schematic diagram of an alternative power converter.

FIG. 3 is a schematic diagram of an alternative power converter.

FIG. 4 is a schematic diagram of an alternative power converter.

FIG. 5 is a schematic diagram of an alternative power converter.

FIG. 6 is a schematic diagram of an alternative power converter.

FIG. 7 is a flow chart of an exemplary method for suppressing resonances that may be used with any of the power converters shown in FIGS. 1-6.

FIGS. 8-10 are graphs illustrating a frequency versus a ripple current generated in an exemplary power converter.

### DETAILED DESCRIPTION OF THE INVENTION

The methods and systems described herein facilitate suppressing resonances in power converters. Power converters including distributed direct current (DC) links may produce non-trivial inductances and may effectively act as inductor-capacitor (LC) circuits with corresponding resonant frequencies. Damping resistors are included at various locations within the power converter to facilitate suppressing the resonances produced by effective LC circuits. Suppressing resonances using the systems and methods described herein facilitates stabilizing operation of the power converter, and facilitates reducing the likelihood of damage to and/or malfunction of the power converter.

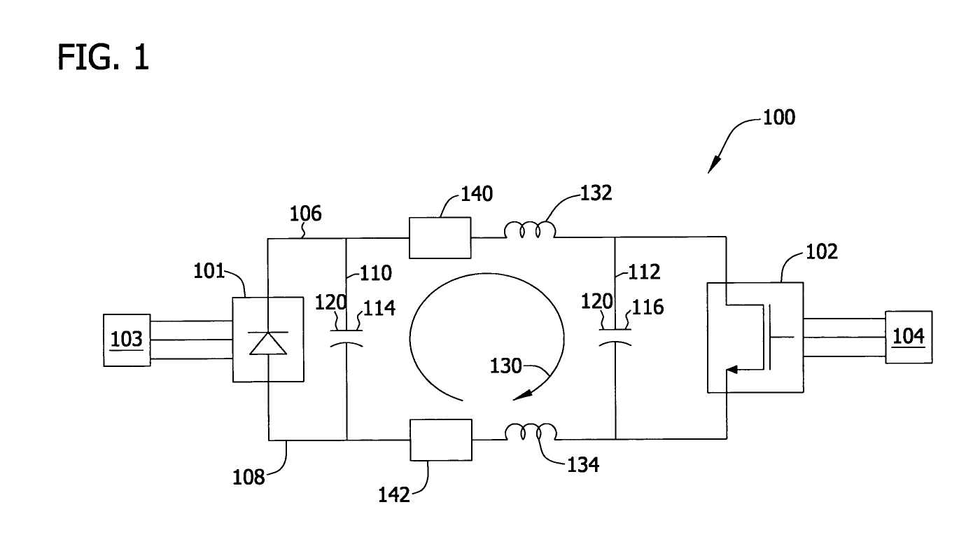

FIG. 1 is a schematic diagram of an exemplary power converter 100. In the exemplary embodiment, power converter 100 is a non-reversible, or unidirectional, power converter that includes an input stage 101 that receives alternating current (AC), and an output stage 102 that outputs AC. More specifically, in the exemplary embodiment, input 101 includes a three-phase rectifier arrangement (details not shown), and output stage 102 includes six phase legs (details not shown) that contain metal-oxide-semiconductor field-effect transistors (MOSFETs), insulated gate bipolar transistors (IGBTs), integrated gate commutated thyristors (IGCTs), and/or any other power device suitable for use in pulse-width modulation (PWM). Alternatively, input stage 101 and output stage 102 include any power device that enables power converter 100 to function as described herein. In the exemplary embodiment, input 101 is coupled to an AC source 103, and output 102 is coupled to an AC load 104. AC source 103 may include, but is not limited to only including, a transformer, a generator, a power grid, and/or any other device configured to supply AC power. AC load 104 may include, but is not limited to only including, a power grid, a motor, an appliance, and/or any other electrical device configured to operate using AC power.

In the exemplary embodiment, converter 100 is a two-level converter that includes a first direct current (DC) bus 106 and a second DC bus 108. Each of first and second DC busses 106 and 108 extends from input stage 101 to output stage 102. Converter 100 also includes a first capacitor leg 110 and a second capacitor leg 112. Each of first and second capacitor legs 110 and 112 extend from first DC bus 106 to second DC bus 108. First capacitor leg 110 includes a first capacitor bank 114, and second capacitor leg 112 includes a second capacitor bank 116. First and second capacitor banks 114 and 116 each include at least one capacitor 120. In the exemplary embodiment, capacitors 120 are polarized capacitors. Alternatively, capacitors 120 may be unpolarized.

First capacitor leg 110, first DC bus 106, second capacitor leg 112, and second DC bus 108 form a current loop 130 that has an effective inductance L. Loop effective inductance L is at least partially based on a total length of bus in first capacitor leg 110, first DC bus 106, second capacitor leg 112, and second DC bus 108. For clarity, in FIG. 1, effective inductance L is represented by a first effective inductor 132 and a second effective inductor 134. In the exemplary embodiment, effective inductors 132 and 134 are balanced, each having an inductance ½L. Alternatively, first and second effective inductors 132 and 134 may have any inductance that enables power converter 100 to function as described herein, including having different inductances from each other.

In the exemplary embodiment, first and second capacitor banks 114 and 116 each have a capacitance ½C. Alternatively, first and second capacitor banks 114 and 116 may have any capacitance that enables power converter 100 to function as described herein, including having different capacitances from each other. Current loop 130 forms a series LC circuit having inductance L and capacitance C. For balanced power converters, the resonant frequency f of the LC circuit formed within power converter 100 is given by Equation 1:

$$f = \frac{1}{2 π \sqrt{LC}} \qquad ( 1 )$$

Accordingly, if power converter 100 is operated at or near the resonant frequency f, and/or has harmonics that are at or near the resonant frequency f, large ripple currents may be generated in power converter 100, damaging one or more components of power converter 100.

To inhibit power converter 100 from resonating at the resonant frequency, a first resistor 140 and a second resistor 142 are incorporated into power converter 100. In the exemplary embodiment, first DC bus 106 includes first resistor 140, and second DC bus 108 includes second resistor 142. Alternatively, first and second resistors 140 and 142 may be incorporated at any location within power converter 100 that enables power converter 100 to function as described herein. Further, any number of resistors may be incorporated within power convertor 100 that enables power converter 100 to function as described herein.

In the exemplary embodiment, first and second resistors 140 and 142 each have a resistance, ½R, such that with first and second resistors 140 and 142, current loop 130 forms a series RLC circuit having inductance L, capacitance C, and resistance R. Alternatively, first and second resistors 140 and 142 may each have any resistance that enables power converter 100 to function as described herein, including having different resistances from each other. The damping ratio ζ of a balanced circuit formed by current loop 130 is given by Equation 2:

$$ζ = \frac{R}{2} \sqrt{\frac{L}{C}} \qquad ( 2 )$$

In the exemplary embodiment, the resistance R is selected to provide a damping ratio of

$$\frac{\sqrt{2}}{2} .$$

More specifically, in terms of inductance L and capacitance C, resistance R is given by Equation (3):

$$R = \sqrt{\frac{2 L}{C}} \qquad ( 3 )$$

Alternatively, resistance R may be selected as any suitable resistance that enables power converter 100 to function as described herein. For example, resistance R may be selected to give a damping ratio less than

$$\frac{\sqrt{2}}{2}$$

in order to reduce power losses caused by the resistance R. By including first and second resistors 140 and 142 in power converter 100, when power converter 100 operates at or near resonant frequency f, and/or has harmonics that are at or near the resonant frequency f, any current oscillations generated as a result of the resonant frequency of current loop 130 will be damped out by first and second resistors 140 and 142.

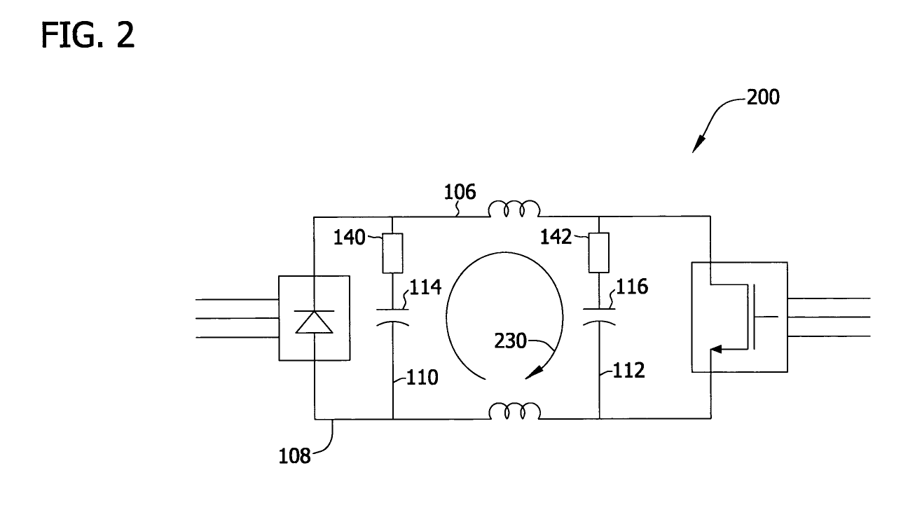

FIG. 2 is a schematic diagram of an exemplary non-reversible power converter 200. Unless otherwise specified, power converter 200 is substantially similar to power converter 100 (shown in FIG. 1), and similar components are labeled in FIG. 2 with the same reference numerals used in FIG. 1. Power converter 200 is substantially similar to power converter 100 (shown in FIG. 1), except that first and second resistors 140 and 142 are coupled in series with respective first and second capacitor banks 114 and 116. More specifically, first capacitor leg 110 includes first resistor 140, and second capacitor leg 112 includes second resistor 142. Similar to the power converter 100 (shown in FIG. 1), a current loop 230 defined by first capacitor leg 110, first DC bus 106, second capacitor leg 112, and second DC bus 108 has a resonant frequency f as given by Equation 1. Equations 2 and 3 are also applicable for use with power converter 200. Moreover, the methods and systems described with respect to power converter 100 (shown in FIG. 1) are also applicable to power converter 200.

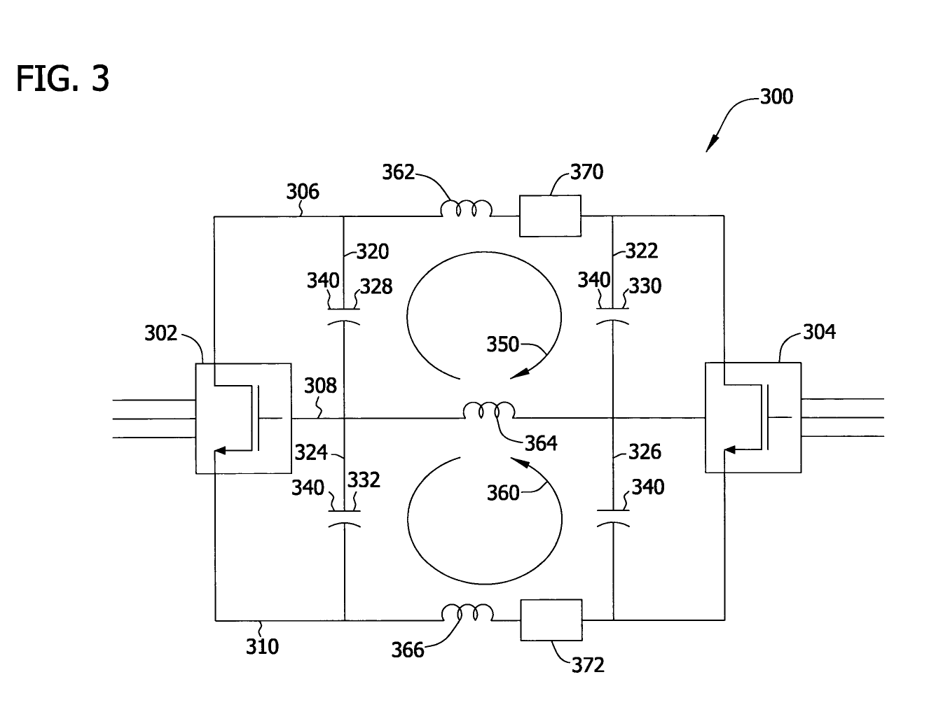

FIG. 3 is a schematic diagram of an exemplary power converter 300, which is composed of two three-level stages. In the exemplary embodiment, power converter 300 is a reversible, or bi-directional, power converter that includes a three-level input stage 302 that receives (or outputs, when reversed) AC and a three-level output stage 304 that outputs (or receives, when reversed) AC. More specifically, in the exemplary embodiment, input stage 302 and output stage 304 each include six phase legs with neutral clamping diodes (details not shown) that contain metal-oxide-semiconductor field-effect transistors (MOSFETs), insulated gate bipolar transistors (IGBTs), integrated gate commutated thyristors (IGCTs), diodes, and/or any other power device suitable for use in pulse-width modulation (PWM). Alternatively, input stage 302 and output stage 304 may include any power device that enables power converter 300 to function as described herein.

Converter 300 is a three-level converter that includes a first DC bus 306, a second DC bus 308, and a third DC bus 310 that each couple input stage 302 to output stage 304. Converter 300 also includes a first capacitor leg 320, a second capacitor leg 322, a third capacitor leg 324, and a fourth capacitor leg 326. First and second capacitor legs 320 and 322 each extend from first DC bus 306 to second DC bus 308, and third and fourth capacitor legs 324 and 326 each extend from second DC bus 308 to third DC bus 310. First capacitor leg 320 includes a first capacitor bank 328, second capacitor leg 322 includes a second capacitor bank 330, third capacitor leg 324 includes a third capacitor bank 332, and fourth capacitor leg 326 includes a fourth capacitor bank 334. First, second, third, and fourth capacitor banks 328, 330, 332, and 334 each include at least one capacitor 340. In the exemplary embodiment, capacitors 340 are polarized capacitors. Alternatively, capacitors 340 may be unpolarized.

In the exemplary embodiment, first capacitor leg 320, first DC bus 306, second capacitor leg 322, and second DC bus 308 form a first current loop 350 that has an effective inductance L. Similarly, third capacitor leg 324, second DC bus 308, fourth capacitor leg 326, and third DC bus 310 form a second current loop 360 having an effective inductance L. The effective inductance L of first current loop 350 is at least partially based on a total length of bus in first capacitor leg 320, first DC bus 306, second capacitor leg 322, and second DC bus 308, and the effective inductance L of second current loop 360 is at least partially based on a total length of bus in third capacitor leg 324, second DC bus 308, fourth capacitor leg 326, and third DC bus 310.

For clarity, in FIG. 3, the effective inductance L of first current loop 350 is represented by a first effective inductor 362 and a second effective inductor 364, and the effective inductance L of second current loop 360 is represented by second effective inductor 364 and a third effective inductor 366. In the exemplary embodiment effective inductors 362, 364, and 366 each have an inductance ½L. Alternatively, first, second, and third effective inductors 362, 364, and 366 may have any inductance that enables power converter 300 to function as described herein, including having different inductances from each other.

Further, first, second, third, and fourth capacitor banks 328, 330, 332, and 334 each have an effective capacitance ½C. Alternatively, first, second, third, and fourth capacitor banks 328, 330, 332, and 334 may have any capacitance that enables power converter 100 to function as described herein, including having different capacitances from each other. First current loop 350 and second current loop 360 each form a series LC circuit having inductance L and capacitance C. The resonant frequencies of each LC circuit are given by Equation 1 (above). Accordingly, if power converter 300 is operated at or near the resonant frequency f, and/or has harmonics that are at or near the resonant frequency f, large ripple currents may be generated in power converter 300, damaging one or more components of power converter 300.

To inhibit power converter 300 from resonating at the resonant frequency, a first resistor 370 and a second resistor 372 are incorporated into power converter 300. In the exemplary embodiment, first DC bus 306 includes first resistor 370, and third DC bus 310 includes second resistor 362. Alternatively, first and second resistors 370 and 372 may be incorporated at any position within power converter 300 that enables power converter 300 to function as described herein. Further, any number of resistors may be incorporated within power convertor 300 that enables power converter 300 to function as described herein.

In the exemplary embodiment, first and second resistors 370 and 372 each have a resistance, R, such that with first and second resistors 370 and 372, first current loop 350 and second current loop 360 each form a series RLC circuit having inductance L, capacitance C, and resistance R. Alternatively, first and second resistors 370 and 372 may each have any resistance that enables power converter 300 to function as described herein, including having different resistances from each other. In the exemplary embodiment, the damping ratios ζ of the circuits formed by current loop 350 and current loop 360 are both given by Equation 2 (above).

In the exemplary embodiment, the resistance R is selected to provide a damping ratio of

$$\frac{\sqrt{2}}{2} .$$

More specifically, in terms of inductance L and capacitance C, resistance R is given by Equation (3) (above). Alternatively, resistance R may be selected as any suitable resistance that enables power converter 300 to function as described herein. For example, resistance R may be selected to give a damping ratio less than

$$\frac{\sqrt{2}}{2}$$

in order to reduce power losses caused by the resistance R. By including first and second resistors 370 and 372 in power converter 300, when power converter 300 operates at or near resonant frequency f, and/or has harmonics that are at or near the resonant frequency f, any current oscillations generated as a result of the resonant frequencies of first and second current loops 350 and 360 will be damped out by first and second resistors 370 and 372.

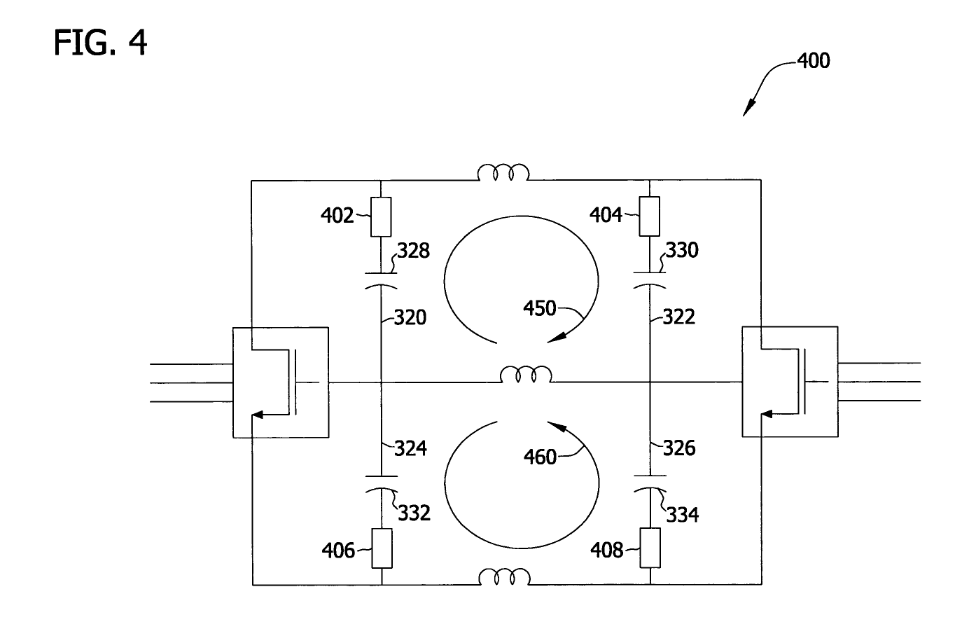

FIG. 4 is a schematic diagram of an exemplary reversible power converter 400. Unless otherwise specified, power converter 400 is substantially similar to power converter 300 (shown in FIG. 3), and similar components are labeled in FIG. 4 with the same reference numerals used in FIG. 3. Power converter 400 is substantially similar to power converter 300 (shown in FIG. 3), except that resistors are coupled in series with respective first, second, third, and fourth capacitor banks 328, 330, 332, and 334. More specifically, first capacitor leg 320 includes a first resistor 402, second capacitor leg 322 includes a second resistor 404, third capacitor leg 324 includes a third resistor 406, and fourth capacitor leg 326 includes a fourth resistor 408. In the exemplary embodiment, first, second, third, and fourth resistors 402, 404, 406, and 408 each have a resistance ½R, such that a first current loop 450 and a second current loop 460 each form a series RLC circuit having inductance L, capacitance C, and resistance R. Alternatively, first, second, third, and fourth resistors 402, 404, 406, and 408 may each have any resistance that enables power converter 400 to function as described herein, including having different resistances from each other.

Similar to power converter 300 (shown in FIG. 3), first current loop 450 and second current loop 460 have a resonant frequency f as given by Equation 1. Equations 2 and 3 are also applicable for use with power converter 400. Moreover, the methods and systems described with respect to power converter 300 (shown in FIG. 3) are also applicable to power converter 400.

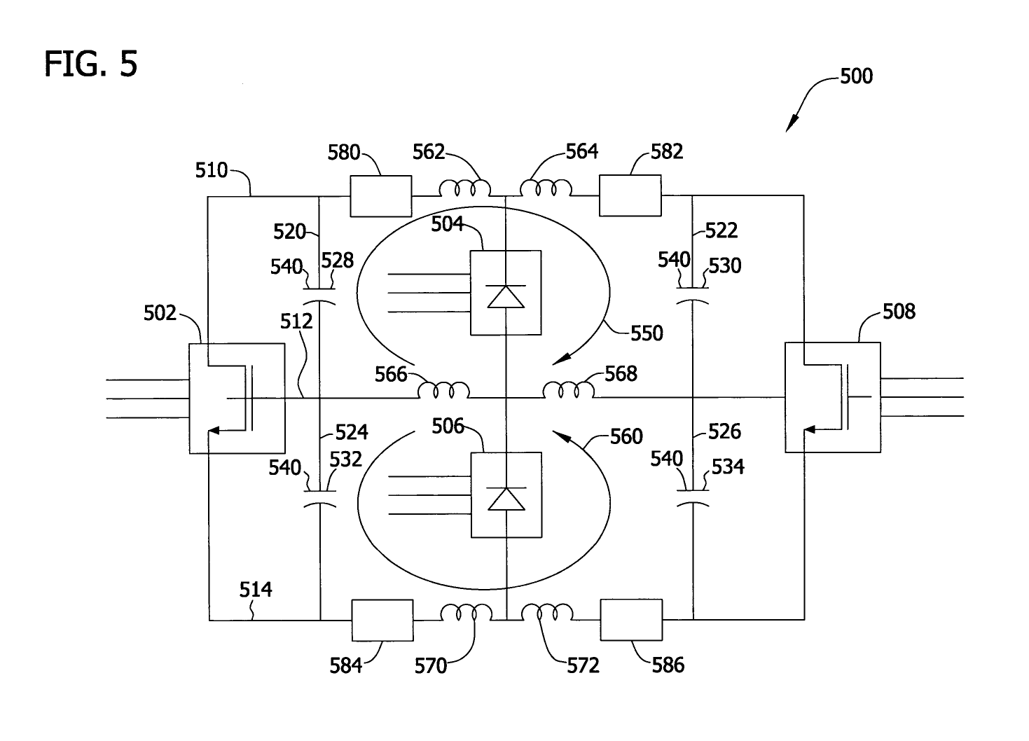

FIG. 5 is a schematic diagram of an exemplary power converter 500. In the exemplary embodiment, power converter 500 is a non-reversible dual-output power converter that includes a first input stage 504 and a second input stage 506 that each receive AC. Power converter 500 also includes a first three-level output stage 502 and a second three-level output stage 508 that output AC. More specifically, in the exemplary embodiment, first output stage 502 and second output stage 508 each include six phase legs (details not shown) that contain metal-oxide-semiconductor field-effect transistors (MOSFETs), insulated gate bipolar transistors (IGBTs), integrated gate commutated thyristors (IGCTs), and/or any other power device suitable for use in pulse-width modulation (PWM), along with neutral clamp diodes. Further, in the exemplary embodiment, first input stage 504 and second input stage 506 each include a three-phase rectifier arrangement (details not shown). Alternatively, first output stage 502, first input stage 504, second input stage 506, and second output stage 508 include any power device that enables power converter 500 to function as described herein.

Converter 500 is a three-level converter that includes a first DC bus 510, a second DC bus 512, and a third DC bus 514 that each couple first output stage 502 to second output stage 508. Converter 500 also includes a first capacitor leg 520, a second capacitor leg 522, a third capacitor leg 524, and a fourth capacitor leg 526. First and second capacitor legs 520 and 522 each extend from first DC bus 510 to second DC bus 512, and third and fourth capacitor legs 524 and 526 each extend from second DC bus 512 to third DC bus 514. First capacitor leg 520 includes a first capacitor bank 528, second capacitor leg 522 includes a second capacitor bank 530, third capacitor leg 524 includes a third capacitor bank 532, and fourth capacitor leg 526 includes a fourth capacitor bank 534. First, second, third, and fourth capacitor banks 528, 530, 532, and 534 each include at least one capacitor 540. In the exemplary embodiment, capacitors 540 are polarized capacitors. Alternatively, capacitors 540 may be unpolarized.

In the exemplary embodiment, first capacitor leg 520, first DC bus 510, second capacitor leg 522, and second DC bus 512 form a first current loop 550 that has an effective inductance L. Similarly, third capacitor leg 524, second DC bus 512, fourth capacitor leg 526, and third DC bus 514 form a second current loop 560 that has an effective inductance L. The effective inductance L of first current loop 550 is at least partially based on a total length of bus in first capacitor leg 520, first DC bus 510, second capacitor leg 522, and second DC bus 512, and the effective inductance L of second current loop 560 is at least partially based on a total length of bus in third capacitor leg 524, second DC bus 512, fourth capacitor leg 526, and third DC bus 514.

For clarity, in FIG. 5, the effective inductance L of first current loop 550 is represented by a first effective inductor 562, a second effective inductor 564, a third effective inductor 566, and a fourth effective inductor 568. Similarly, the effective inductance L of second current loop 560 is represented by third effective inductor 566, fourth effective inductor 568, a fifth effective inductor 570, and a sixth effective inductor 572. In the exemplary embodiment, effective inductors 562, 564, 566, 568, 570, and 572 each have an inductance ¼L. Alternatively, first, second, and third, fourth, fifth, and sixth effective inductors 562, 564, 566, 568, 570, and 572 may have any inductance that enables power converter 500 to function as described herein, including having different inductances from each another.

Further, first, second, third, and fourth capacitor banks 528, 530, 532, and 534 each have an effective capacitance ½C. Alternatively, first, second, third, and fourth capacitor banks 528, 530, 532, and 534 may have any capacitance that enables power converter 500 to function as described herein, including having different capacitances from each other. First current loop 550 and second current loop 560 each form a series LC circuit having inductance L and capacitance C. The resonant frequencies of each LC circuit are given by Equation 1 (above). Accordingly, if power converter 500 is operated at or near the resonant frequency f, and/or has harmonics that are at or near the resonant frequency f, large ripple currents may be generated in power converter 500, damaging one or more components of power converter 500.

To inhibit power converter 500 from resonating at the resonant frequency, a first resistor 580, second resistor 582, third resistor 584, and fourth resistor 586 are incorporated into power converter 500. In the exemplary embodiment, first DC bus 510 includes first resistor 580 and second resistor 582, and third DC bus 514 includes third resistor 584 and fourth resistor 586. Alternatively, first, second, third, and fourth resistors 580, 582, 584, and 586 may be incorporated at any position within power converter 500 that enables power converter 500 to function as described herein. Further, any number of resistors may be incorporated within power convertor 500 that enables power converter 500 to function as described herein.

In the exemplary embodiment, first, second, third, and fourth resistors 580, 582, 584, and 586 each have a resistance, ½R, such that first and second current loops 550 and 560 each form a series RLC circuit having inductance L, capacitance C, and resistance R. Alternatively, first, second, third, and fourth resistors 580, 582, 584, and 586 may each have any resistance that enables power converter 500 to function as described herein, including having different resistances from each other. In the exemplary embodiment, the damping ratios ζ of the circuits formed by first current loop 550 and second current loop 560 are both given by Equation 2 (above).

In the exemplary embodiment, the resistance R is selected to provide a damping ratio of

$$\frac{\sqrt{2}}{2} .$$

More specifically, in terms of inductance L and capacitance C, resistance R is given by Equation (3) (above). Alternatively, resistance R may be selected as any suitable resistance that enables power converter 500 to function as described herein. For example, resistance R may be selected to give a damping ratio less than

$$\frac{\sqrt{2}}{2}$$

in order to reduce power losses caused by the resistance R. By including first, second, third, and fourth resistors 580, 582, 584, and 586 in power converter 500, when power converter 500 operates at or near resonant frequency f, and/or has harmonics that are at or near the resonant frequency f, any current oscillations generated as a result of the resonant frequencies of first and second current loops 550 and 560 will be damped out by first, second, third, and fourth resistors 580, 582, 584, and 586.

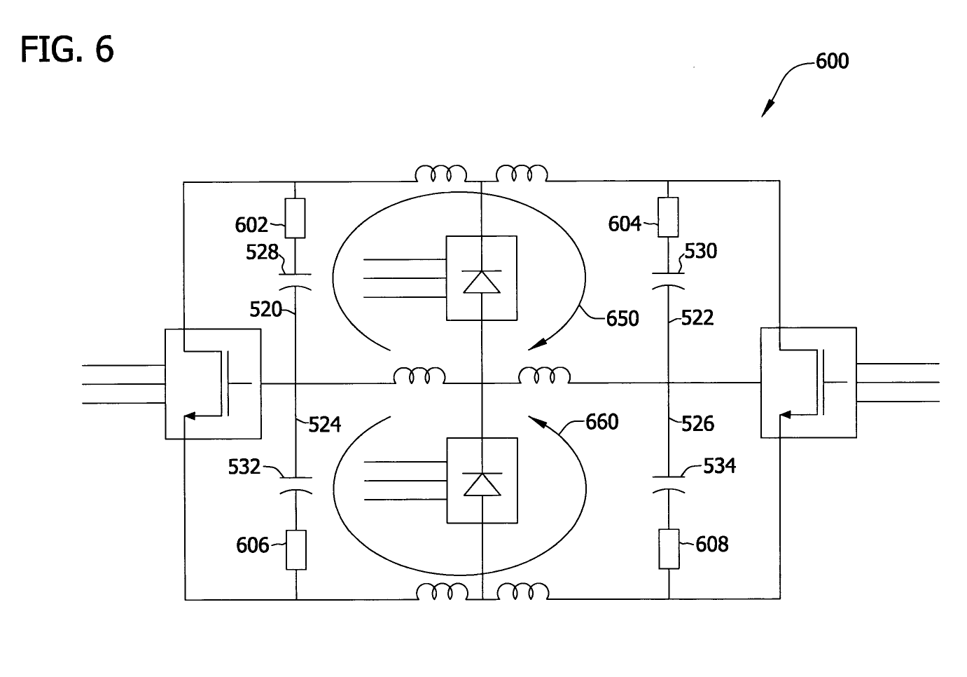

FIG. 6 is a schematic diagram of an exemplary non-reversible dual-output power converter 600. Unless otherwise specified, power converter 600 is substantially similar to power converter 500 (shown in FIG. 5), and similar components are labeled in FIG. 6 with the same reference numerals used in FIG. 5. Power converter 600 is substantially similar to power converter 500 (shown in FIG. 5), except that resistors are coupled in series with first, second, third, and fourth capacitor banks 528, 530, 532, and 534. More specifically, first capacitor leg 520 includes a first resistor 602, second capacitor leg 522 includes a second resistor 604, third capacitor leg 524 includes a third resistor 606, and fourth capacitor leg 526 includes a fourth resistor 608. In the exemplary embodiment, first, second, third, and fourth resistors 602, 604, 606, and 608 each have a resistance ½R, such that a first current loop 650 and a second current loop 660 each form a series RLC circuit having inductance L, capacitance C, and resistance R. Alternatively, first, second, third, and fourth resistors 602, 604, 606, and 608 may each have any resistance that enables power converter 600 to function as described herein, including having different resistances from each other.

Similar to power converter 500 (shown in FIG. 5), first current loop 650 and second current loop 660 have a resonant frequency f as given by Equation 1. Equations 2 and 3 are also applicable for use with power converter 600. Moreover, the methods and systems described with respect to power converter 500 (shown in FIG. 5) are also applicable to power converter 600.

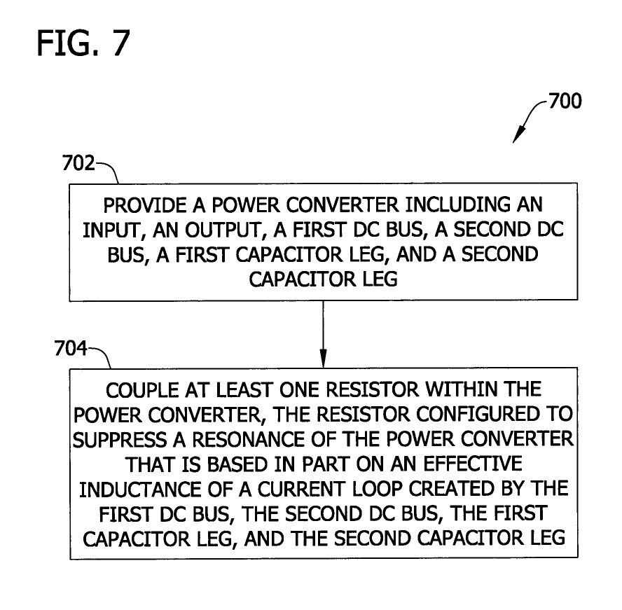

FIG. 7 is a flow chart of an exemplary method 700 that may be used to suppress resonances generated when using a power converter. In method 700, a power converter, such as, for example, power converter 100, is provided 702. The power converter includes an input stage configured to receive alternating current (AC) and an output stage configured to output AC, such as, for example, input stage 101 and output stage 102. The power converter also includes a first direct current (DC) bus coupling the input stage to the output stage and a second DC bus coupling the input stage to the output stage, such as, for example, first DC bus 106 and second DC bus 108. The power converter also includes a first capacitor leg coupling the first DC bus to the second DC bus, and a second capacitor leg coupling the first DC bus to the second DC bus, such as, for example, first capacitor leg 110 and second capacitor leg 112. The first DC bus, the second DC bus, the first capacitor leg, and the second capacitor leg form a current loop having an effective inductance, such as, for example, current loop 130.

At least one resistor is coupled 704 within the power converter, such as, for example first resistor 140 and/or second resistor 142. The at least one resistor is configured to suppress a resonance of the power converter. The suppressed resonance is based at least in part on the effective inductance of the current loop.

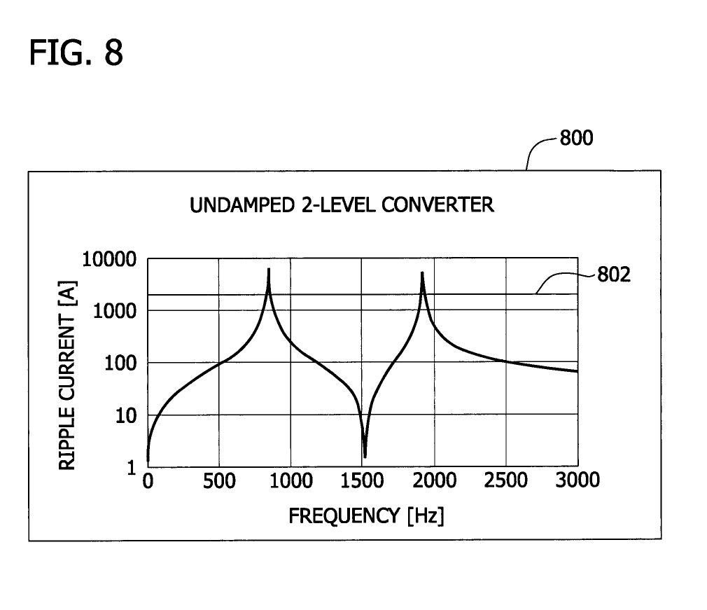

FIGS. 8-10 are graphs illustrating the frequency versus the ripple current generated in an exemplary two-level power converter, for example, power converter 100. In FIG. 8, a graph 800 illustrates the frequency in Hertz (Hz) versus the ripple current in Amperes (A) for a power converter that does not include resistors to suppress resonances. As shown in graph 800, at certain frequencies, the ripple current exceeds a current threshold 802. Current threshold 802 may represent, for example, an operating capability of a bus in the power converter. Accordingly, when the ripple current exceeds current threshold 802, one or more components of the power converter may overheat and/or malfunction.

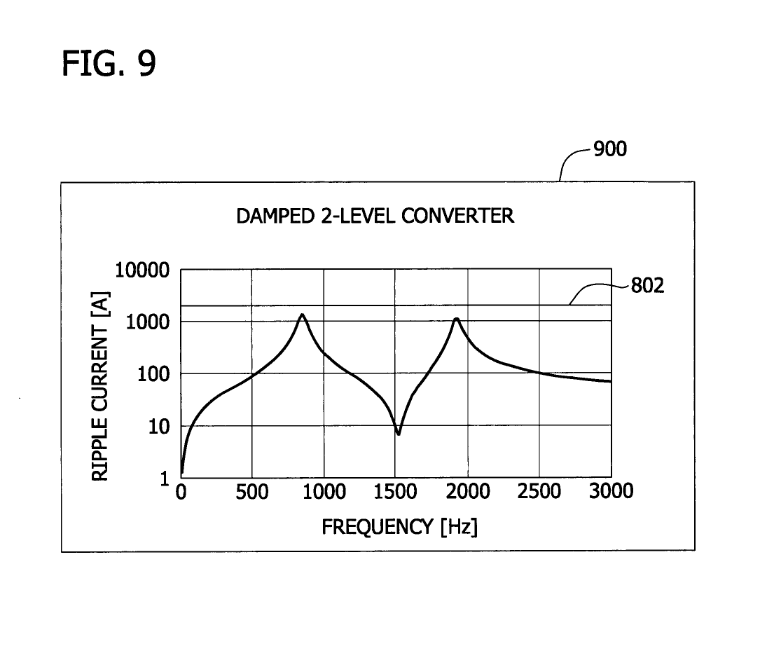

In FIG. 9, a graph 900 illustrates the frequency versus the ripple current generated for a power converter that does include resistors to suppress resonances. As shown in graph 900, while the ripple current varies in response to the frequency, the ripple current is kept below current threshold 802 for all frequencies. Accordingly, the resistors facilitate preventing one or more components of the power converter from overheating and/or malfunctioning.

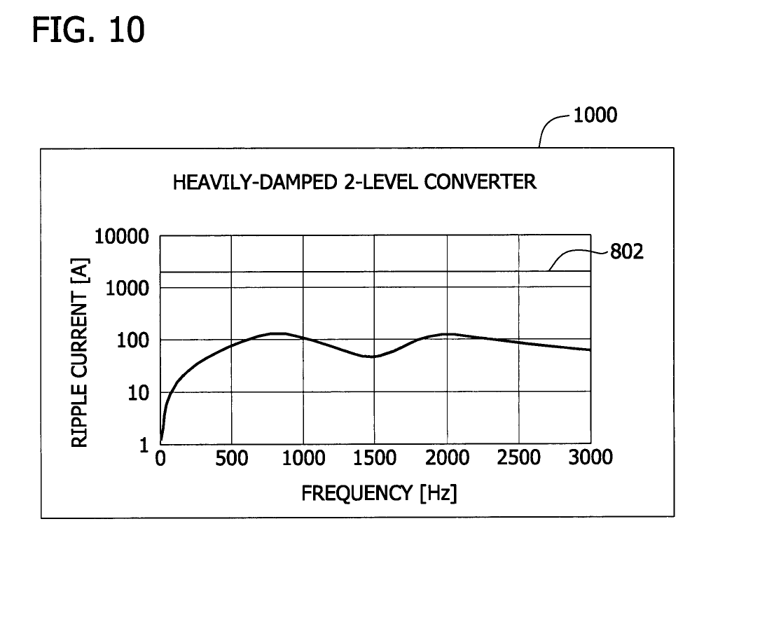

In FIG. 10, a graph 1000 illustrates the frequency versus the ripple current generated for a power converter that is heavily damped with resistors. As compared to graph 900, the ripple current is more suppressed in graph 1000. However, as the damping of the power converter increases, the resistors absorb significant amounts of power, reducing the overall efficiency of the converter and increasing overall cooling requirements.

As compared to known power converters, the methods and systems described herein enable larger and more resilient power converters to be manufactured and operated. Because the resistors described herein suppress resonances in power converters, non-trivial inductances produced by distributed DC link power converters will be less likely to generate resonating currents that could result in component damage and/or malfunction. Further, the methods and systems described herein will reduce the maintenance and repair costs associated with known power converters, as the methods and systems described herein reduce the likelihood of component damage and/or malfunction.

The methods and systems described herein facilitate suppressing resonances in power converters. Power converters including distributed DC links may produce non-trivial inductances and may effectively act as LC circuits with corresponding resonant frequencies. Damping resistors are included at various locations within the power converter to facilitate suppressing the resonances produced by effective LC circuits. Suppressing resonances using the systems and methods described herein facilitates stabilizing operation of the power converter, and facilitates reducing the likelihood of damage to and/or malfunction of the power converter.

Exemplary embodiments of methods and systems for suppressing resonances in power converters are described above in detail. The methods and systems described herein are not limited to the specific embodiments described herein, but rather, components of the systems and/or steps of the methods may be utilized independently and separately from other components and/or steps described herein. For example, the methods and systems described herein may have other applications not limited to practice with power converters, as described herein. Rather, the methods and systems described herein can be implemented and utilized in connection with various other industries.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power converter comprising:
an input stage configured to receive alternating current (AC);
an output stage configured to output AC;
a first direct current (DC) bus coupling said input stage to said output stage;
a second DC bus coupling said input stage to said output stage;
a first capacitor leg coupling said first DC bus to said second DC bus;
a second capacitor leg coupling said first DC bus to said second DC bus, said first DC bus, said second DC bus, said first capacitor leg, and said second capacitor leg form a current loop having an effective inductance; and
at least one resistor configured to suppress a resonance of said power converter, wherein the resonance is based at least in part on the effective inductance of the current loop.

2. A power converter in accordance with claim 1, wherein said at least one resistor is coupled to at least one of said first DC bus and said second DC bus.

3. A power converter in accordance with claim 1, wherein said at least one resistor is coupled to at least one of said first capacitor leg and said second capacitor leg.

4. A power converter in accordance with claim 1, wherein said power converter is one of a two-level converter and a three-level converter.

5. A power converter in accordance with claim 1, wherein said power converter is a reversible converter in which said output stage and said input stage are configured to be reversed during operation.

6. A power converter in accordance with claim 1, wherein said at least one resistor has a resistance selected to provide a damping ratio for the current loop of approximately
$$\frac{\sqrt{2}}{2} .$$

7. A power converter in accordance with claim 1, wherein said at least one resistor has a resistance selected to provide a damping ratio for the current loop of less than approximately
$$\frac{\sqrt{2}}{2}$$
to facilitate reducing power losses caused by said at least one resistor.

8. A system for suppressing resonances in a power converter, said system comprising:
an alternating current (AC) source;
an AC load; and
a power converter comprising:
an input stage configured to receive AC, said input stage coupled to said AC source;
an output stage configured to output AC, said output stage coupled to said AC load;
a first direct current (DC) bus coupling said input stage to said output stage;
a second DC bus coupling said input stage to said output stage;
a first capacitor leg coupling said first DC bus to said second DC bus;
a second capacitor leg coupling said first DC bus to said second DC bus, said first DC bus, said second DC bus, said first capacitor leg, and said second capacitor leg form a current loop having an effective inductance; and
at least one resistor configured to suppress a resonance of said power converter, wherein the resonance is based at least in part on the effective inductance of the current loop.

9. A system in accordance with claim 8, wherein said at least one resistor is coupled to at least one of said first DC bus and said second DC bus.

10. A system in accordance with claim 8, wherein said at least one resistor is coupled to at least one of said first capacitor leg and said second capacitor leg.

11. A system in accordance with claim 8, wherein said power converter is one of a two-level converter and a three-level converter.

12. A system in accordance with claim 8, wherein said power converter is a reversible converter in which said output stage and said input stage are configured to be reversed during operation.

13. A system in accordance with claim 8, wherein said at least one resistor has a resistance selected to provide a damping ratio for the current loop of approximately
$$\frac{\sqrt{2}}{2} .$$

14. A method of suppressing resonances in a power converter, said method comprising:
providing a power converter, the power converter comprising an input stage configured to receive alternating current (AC), an output stage configured to output AC, a first direct current (DC) bus coupling the input stage to the output stage, a second DC bus coupling the input stage to the output stage, a first capacitor leg coupling the first DC bus to the second DC bus, and a second capacitor leg coupling the first DC bus to the second DC bus, the first DC bus, the second DC bus, the first capacitor leg, and the second capacitor leg form a current loop having an effective inductance;
coupling at least one resistor within the power converter; and
suppressing a resonance of the power converter using the at least one resistor, the resonance based at least in part on the effective inductance of the current loop.

15. A method in accordance with claim 14, wherein coupling at least one resistor comprises coupling at least one resistor to at least one of the first DC bus and the second DC bus.

16. A method in accordance with claim 14, wherein coupling at least one resistor comprises coupling at least one resistor to at least one of the first capacitor leg and the second capacitor leg.

17. A method in accordance with claim 14, wherein providing a power converter comprises providing one of a two-level power converter and a three-level power converter.

18. A method in accordance with claim 14, wherein providing a power converter comprises providing a reversible power converter in which the output stage and the input stage are configured to be reversed during operation.

19. A method in accordance with claim 14, wherein coupling at least one resistor comprises coupling at least one resistor within the power converter such that a damping ratio for the current loop is approximately
$$\frac{\sqrt{2}}{2} .$$

20. A method in accordance with claim 14, wherein coupling at least one resistor comprises coupling at least one resistor within the power converter such that a damping ratio for the current loop is less than approximately
$$\frac{\sqrt{2}}{2}$$
to facilitate reducing power losses caused by the at least one resistor.
